(19) United States
(12) Patent Application Publication
(10) Pub. No.: US 2004/0104173 A1
(43) Pub. Date: Jun. 3, 2004

(54) Installation for treating samples continuously by separation on a stationary phase under forced flow

(76) Inventors: Michel Manach, Meudon (FR); Emil Mincsovics, Szentendre (HU); Barnabas Tapa, Budapest (HU)

Correspondence Address: BIRCH STEWART KOLASCH & BIRCH, PO BOX 747, FALLS CHURCH, VA, 22040-0747, US

(21) Appl. No.: 10/678,114

(22) Filed: Oct. 6, 2003

Related U.S. Application Data
(63) Continuation of application No. PCT/FR02/01201, filed on Apr. 5, 2002.

(30) Foreign Application Priority Data
Apr. 6, 2001 (FR) 01/04745

(51) Int. Cl. B01D 15/08

(52) U.S. Cl. 210/656; 210/96.1; 210/143; 210/198.2; 73/61.55; 73/61.56; 422/70; 210/660

(57) ABSTRACT

An installation for treating samples by chromatographic separation comprises: i) means (1, 2, 4) for feeding moving phase, means (14) for supplying samples, and a multiplicity of injector means (10-i), each comprising a first inlet (11-i) for receiving a sample, a second inlet (8-i) connected to the feed means, and an outlet (13-i) for delivering the moving phase and/or the sample; ii) a stationary phase (3) defining a multiplicity of sample treatment channels (12-i), each starting at a first selected location (19-i) and terminating at a second selected location (20-i); and iii) a chamber (17) housing the stationary phase (3) and including pressurizing means for applying an external pressure to one face of the stationary phase, a multiplicity of inlets, each connected to the outlet (13-i) of an injector (10-i) to deliver the moving phase and/or the samples to the first locations (19-i), and a multiplicity of outlets (18-i) for discharging the multiplicity of samples treated in the channels (12-i) that have reached the various second locations.

The invention relates to the field of separating the constituents of complex samples by chromatography.

The chromatographic techniques known as “column liquid chromatography” and “planar chromatography” serve to separate the constituents of a sample in an attractor medium referred to as a “stationary phase” by using a carrier fluid referred to as the “moving phase”.

These techniques differ in the type of stationary phase used and in the way in which the sample is introduced into the stationary phase. More precisely, in column liquid chromatography (also known as high performance liquid chromatography (HPLC)), the sample and the moving phase are introduced into an injection loop which feeds a generally cylindrical column containing the stationary phase. The operator controls the flow rate of the moving phase which is injected continuously, and consequently sample injection takes place in a balanced system. The separated-out constituents of the sample leave the column and are then eluted and detected continuously. That technique is suitable for full automation, however it does not enable a plurality of samples to be treated simultaneously in the same column; only by juxtaposing a plurality of independent installations is it possible to perform treatment in parallel. Furthermore, that technique consumes a large quantity of moving phase.

In planar chromatography, two sub-techniques are distinguished known as thin layer chromatography (TLC) and forced flow chromatography (more widely known as overpressure layer chromatography or optimum performance layer chromatography (OPLC)). In those two planar sub-techniques, different samples are deposited at selected locations on a layer forming the stationary phase, and they are then entrained by the moving phase in a known order that is a function of their retention. In TLC, the samples are placed on a stationary phase prior to injecting the moving phase. The stationary phase is partially in contact with the atmosphere so the system actually constituted is in fact a three-phase system. The samples are not eluted and detection is performed in an external detector after the moving phase has evaporated. In OPLC, the stationary phase is hermetically isolated from the atmosphere and external pressure is applied thereto. The samples can be injected either prior to setting the moving phase into motion, as is the case for TLC, or else once the system is in equilibrium, as is the case for HPLC. As a result, detection can be formed either semicontinuously or else discontinuously. These two sub-techniques make it possible to perform successive detection operations on a multiplicity of samples that have just been treated, but full automation is not possible. In addition, they operate in discontinuous manner, thereby restricting productivity while increasing the costs of treating samples.

An object of the invention is to solve the above-described drawbacks in full or in part.

To this end, the invention provides an installation for treating samples by chromatographic separation, in which installation there are provided:

feed means enabling at least one moving phase to be delivered at a selected flow rate and/or a selected limiting pressure;

supply means enabling a multiplicity of samples to be delivered separately;

a multiplicity of injector means (e.g. of the internal or external loop injector valve type) each presenting at least a first inlet for receiving a sample delivered by the supply means, a second inlet for receiving the moving phase(s), and an outlet for delivering the sample and/or the moving phase(s);

at least one stationary phase which defines at least one multiplicity of sample treatment channels, each channel beginning at a first selected location and each terminating at a second selected location; and

at least one chamber housing the stationary phase and comprising, firstly external pressurization means for applying external pressure of selected magnitude on one face of the stationary phase, secondly a multiplicity of inlets each connected to the outlet of respective injector means to deliver the samples and/or the moving phase(s) to the various first locations, and thirdly at least a first multiplicity of outlets for discharging the multiplicity of samples that have been treated in the channels and that have reached the various second locations.

The term “moving phase” should be understood broadly. It covers any fluid enabling the constituents of a sample to be moved over a stationary phase, whether that fluid is a liquid such as an eluent or a gas such as air enabling a solvent that has previously been introduced into the separation chamber to be expelled (or pushed away).

The invention thus presents the advantages of HPLC type installations so far as automation is concerned, together with the advantages of OPLC type installations so far as simultaneously treating a multiplicity of samples on a single stationary phase is concerned.

According to another characteristic of the invention, the installation also has collector means enabling each treated sample and/or moving phase delivered via each of the outlets of the chamber to be selected in individual manner in order to be stored in a receptacle. Collection may be of the volume type, of the time type, or of the type based on detecting a signal threshold. Furthermore, the collector means may comprise a multiplicity of outlets and of selector means for delivering each collected sample and/or moving phase to one of the receptacles and/or to one of the outlets, as appropriate.

According to yet another characteristic of the invention, the installation has first detector means (preferably non-invasive means such as detectors of visible or ultraviolet photons, for example), enabling the treated samples that are delivered via the outlets of the chamber to be analyzed simultaneously or sequentially. These first detector means may be installed between the outlets of the chamber and the collector means, or else downstream from the outlets of the collector means (e.g. if they include selector means).

Advantageously, the installation may also have second detector means capable of performing analyses other than those performed with the first detector means either simultaneously on a multiplicity of paths or sequentially on a single path, e.g. downstream from the first detector means. The second detector means are preferably installed in parallel with the collector means, e.g. performing detection by fluorescence, by measuring refraction, by light diffraction, or by mass spectrometry.

The installation may also have other characteristics taken separately or in combination, and in particular:

memory means for storing the results delivered by the various detector means;

supply means comprising a sample-handling device that is displaceable in three dimensions enabling samples for treatment to be extracted from individualized containers in order to feed the first inlets of the various injector means;

a chamber arranged to receive an extractable drawer comprising the stationary phase, possibly integrated in an extractable cassette; and

regulator means for controlling the temperature of at least a portion of the stationary phase inside the chamber.

The above-described installation is particularly adapted to the following applications: screening molecules, in particular by coupling with ligands (immunochromatography or molecular hybridization), separation by ion exchange, preparing samples for combinatorial chemistry, or extracting natural substances.

Other characteristics and advantages of the invention appear on examining the following detailed description and from the accompanying drawings, in which:

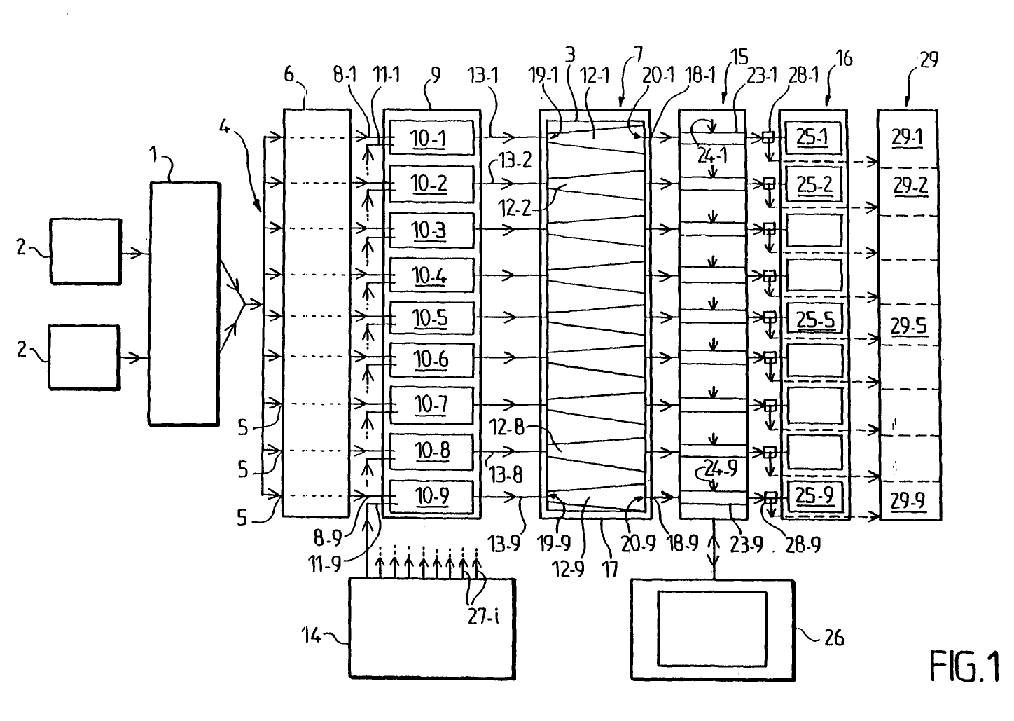

FIG. 1 is a diagram showing an embodiment of an installation of the invention;

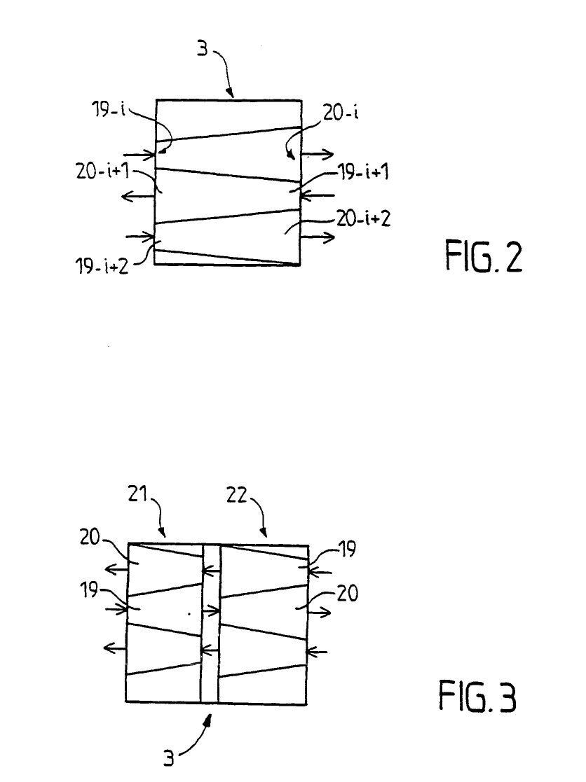

FIG. 2 is a longitudinal section view through a variant of a two-directional type flat column; and

FIG. 3 is a longitudinal section view through two two-directional flat columns connected in series.

In the following detailed description, reference is made to an installation for treating complex samples by chromatographic separation under forced flow (or OPLC). The term “treatment” of a sample is used herein mainly to designate separating the constituents that make it up, optionally associated with one or more in-line and/or off-line analyze(s) of its separated constituents.

The installation shown in FIG. 1 comprises firstly a pump module 1, fed by a carrier fluid tank 2, and preferably by at least two tanks containing different carrier fluids.

The carrier fluids (or moving phases) are generally solvents that are to be introduced into the installation at a selected pressure that varies depending on the resistance to flow within the stationary phase 3 (or flat separation column), which is described below. The pump module 1 comprises one or more constant flow rate pumps that operate at programmable flow rates and that are capable of operating sequentially or simultaneously depending on requirements, for example in order to generate a mixture in the form of a continuous gradient. The solvents are distributed under a pressure having the same order of magnitude as the external pressure applied to the flat separation column 3. To this end, the pumps are designed to deliver pressures lying in the range about 1 bar to about 100 bars, and typically of the order of 50 bars.

The gradients are implemented either under high pressure in a mixing chamber (not shown) by programming the relative flow rates delivered by the pumps using a control module of the installation (not shown), or else under low pressure using a valve capable of alternating quickly and under programmed control. The pumps may be arranged so as to be capable of receiving a plurality of sets of heads offering a wide range of flow rates. The external pressure applied to the plates may be regulated as a function of the pressure needed for regulating the separator unit.

The dead volume which arises between the instant of the solvent mixture being prepared and the instant of its introduction into the column 3 is preferably minimized by using small volume pump heads and by feeding the flat column 3 by capillaries of small inside diameter.

Also preferably, the pump module 1 is arranged so as to allow organic solvents to be used or aqueous saline solvents, or indeed combinations of such solvents.

The outlets from the pump module 1 feed the inlet of a distributor 4 e.g. in the form of a star, or having any other form that enables identical carrier fluid flow rates to be ensured at the various feed inlets 5 of a controller 6. The number of inlets is preferably identical to the number of separation channels 12-i formed in the stationary phase 3.

Naturally, each outlet of the distributor 4 which feeds an inlet 5 of the controller 6 may be fitted with a valve that controls access in such a manner as to enable treatment to be performed on a restricted number of channels 12 in the flat column 3, thereby avoiding running certain portions of the flat column empty.

Naturally, in a variant, distribution can also be implemented in the form of micro-fluidic circuits of the type described below with reference to the separator module 7.

The controller 6 is fitted with a device enabling the characteristics of the carrier fluids flowing in the installation to be monitored. By way of example, the device can be constituted by pressure sensors serving to estimate the resistance being offered to the programmed fluid flow rate. The controller 6 may also have devices for balancing the pressures in the various channels 12 of the flat column 3. By way of example, these pressure-balancing devices may operate by controlling flow. For example they may be constituted by variable flow rate valves.

The various outlets from the controller 6 (there are nine in this case) feed first inlets 8-i (in this case i=1 to 9) of an injection module 9. This module preferably comprises a multiplicity of injection valves 10-i of the “internal loop” type or of the “external loop” type. Such loop type injection valves are well known to the person skilled in the art, and consequently they are not described in detail herein. In addition to a first inlet 8-i, each includes a second inlet 11-i for receiving a sample, a first outlet 13-i for feeding the channel 12-i of the flat column 3, and preferably also a second outlet (not shown) for discharging overflow of solvent (carrier fluid or indeed eluent) and/or sample overflow.

The second inlets 11-i of the various injection valves 10-i are either all connected to the parallel outlets of a sample-supply device 14 (which in this case has as many outlets 27-i are there are injection valves, as shown), or else they are suitable for being connected to the end of a robot arm capable of moving in three dimensions (of the XYZ type).

The sample supply device (or robot) 14 may be used either to introduce previously-prepared samples into the second inlets 11-i of the injection module 9, or else to prepare samples prior to delivering them to the said second inlets 11-i. In which case, sample preparation may consist in the sample being diluted in the solvent which feeds the first inlet 8-i of each injection valve 10-i. To enable this type of preparation, it may be advantageous to couple the pump module 1 to the supply device 14.

Other types of sample preparation can be envisaged. Thus, it is possible for one of the samples for treatment to be joined with a molecule that modifies its specific behavior during chromatographic separation in the flat column 3, or that serves to facilitate detection of certain molecules of interest, e.g. by fluorescence.

The method of preparation by dilution may also be used for generating calibration ranges.

The introduction of an optionally-prepared sample may be performed by means of a syringe introduced into the second inlet 11-i of each valve 10-i. This step of supplying the injection valves 10-i may be performed during a preceding sample separation cycle. Naturally, instead of a single needle handled by an arm that can be moved in three dimensions, it is possible to provide a multiplicity of needles (as many needles as there are second inlets 11-i to the injection module 9), thereby enabling samples to be introduced simultaneously.

The injection valves 10-i may possess their own drive means, or else they may share common drive means controlled by the supply robot or directly by the programmable control module. As mentioned above, the control module preferably controls all of the components of the installation, and in particular the pump module 1, the distributor 4, the controller 6, the supply robot 14, the various injection valves 10-i, the separator module 7, and a detector module 15 and a collector module 16 that are described below.

The first outlet 13-i of the injection valves 10-i feed the various inlets of the separator module 7. This module is implemented in the form of a chamber 17 adapted to receive at least one layer forming the flat separation column 3, which layer defines one or two stationary phases. This layer known as a “sorbent” layer may be constituted by a powder or particles based on inorganic components such as silicate gel, alumina, magnesium silicate, talc, or based on organic components such as cellulose, synthetic resin, polyamides, or indeed on derivatives or mixtures of some of said components. It is deposited on a support plate. It is clear that the material used and its surface state (grain size, porosity, and the like) depend on the type of samples to be treated.

Naturally, injection may be performed simultaneously (i.e. in parallel) or sequentially (i.e. in series).

Since the separator chamber 17 is of the kind conventionally used in OPLC, it is not described in detail below. In other words, any type of OPLC chamber can be used in an installation of the invention, whether a conventional chamber having a peripheral gasket or a complex chamber with pressure control of the type described in the Applicant's patent document FR 00/00063. Other types of OPLC chamber may also be envisaged. Thus, it is possible to envisage a chamber in which the constituents of the samples are separated by using the bottom face of the stationary phase. It is also possible to envisage a chamber in which the constituents of the samples are separated by simultaneously making use of the top and the bottom faces of the stationary phase.

The chamber 17 preferably includes an extractable drawer that is opened and closed automatically under the control of the control module, and in which it is possible to place one or more flat columns 3, together with a device for exerting external pressure on one of the faces (top or bottom) of the (or each) flat column 3. Naturally, the chamber 17 has a multiplicity of inlets for feeding the various channels 12-i formed in the flat column 3. Furthermore, the chamber 17 has a multiplicity of outlets 18-i for discharging the fluids and/or the treated samples into the various separation channels 12-i. The extractable drawer may form part of an extractable cassette made in the form of a box fitted with inlets/outlets and with fluidic circuits.

As shown in FIGS. 1 to 3, the channels 12-i formed in the flat column 3 are preferably of trapezoidal shape when seen in longitudinal section, with the short side of the trapezoid being used as an inlet 19-i for channel 12-i and the long side serving as the outlet 20-i of said channel.

This trapezoidal shape is particularly advantageous insofar as it enables a (linearly) decreasing feed field to be set up along the longitudinal axis of the channel 12-i. Thus, the posterior portion of a given peak possesses speed greater than that of the anterior portion of said peak, which enhances the focusing of the peaks.

As shown in FIGS. 2 and 3, in order to optimize the number of channels 12-i, it is possible on a given flat column 3 to form alternating first channels 12-i, 12-i+2 (e.g. of trapezoidal shape) having inlets 19-i, 19-i+2 all lying along one side, together with second trapezoidal channels 12-i+1 with outlets 20-i+1 placed beside the inlets of the first channels. Naturally, under such circumstances, the separator chamber 17 has alternating inlets and outlets 19-i and 20-i on both sides.

In another variant, the inlets 13-i of the chamber 17 may feed a first selected location placed substantially in the middle of the flat column 3 and feeding two series of channels 12-i facing in opposite directions, thereby implementing a two-directional mode separation having a multiplicity of inlets and two multiplicities of outlets, the two multiplicities of channels 12 thus formed between them optionally being formed in different materials.

When using channels of trapezoidal shape, instead of beginning separation at the short side of the trapezoid (which is suitable for elution using an isocratic type solvent), it is possible to begin separation beside the long side of the trapezoid (which is suitable when performing elution by means of a solvent gradient).

Naturally, other channel shapes can be envisaged, and in particular channels presenting funnel-shaped inlet (or flared inlet) extended by a main portion that is substantially linear.

By definition, the term “first selected location” designates a location feeding the inlet 19-i of a channel 12-i, and the term “second selected location” designates a location fed by the outlet 20-i of a channel 12-i.

In another variant, two (or more) flat columns may be superposed one above the other, being separated via their bases. In which case, the inlets and the outlets of the chamber may be superposed.

In another variant shown in FIG. 3, it is possible to place two different flat columns in series, or else a flat column 3 constituted by two portions 21 and 22 made of materials that are preferably different or of the same material but presenting different properties, for example different grain sizes. By way of example, it is possible to begin with a large grain size on entry over a short distance followed by a finer grain size over a longer distance.

The flat columns 3 are constituted of a single stationary phase placed, preferably uniformly, on a single support (which may be a normal phase support or an inverted phase support, or indeed a support for ion exchange or for affinity chromatography, or for exclusion chromatography).

Another variant consists in placing two flat columns in series e.g. in two successive chambers, in which two different chromatography techniques are implemented, such as, for example, exclusion chromatography followed by ion exchange chromatography.

It is also possible to envisage “separating” the channels by fluidic barriers, e.g. by making an eluent (or the eluent) flow between said channels. This can serve to reduce significantly the edge effects of the sample fronts within the channels.

It is also possible to envisage adding, upstream from the chamber inlet 17, a respective chromatography column for each channel 12-i of the flat column 3 which is received in said chamber.

The stationary phase 3 placed inside the chamber 17 presents standard dimensions, typically 200 millimeters (mm) by 200 mm by 0.005 mm to 5 mm.

Furthermore, and as mentioned above, the chamber includes pressurizing means enabling an external pressure to be applied lying in the range about 1 bar to about 100 bars, and typically being 50 bars. Preferably, the pressure may be fixed in steps of 1 bar+0.5 bars. Furthermore, the external pressure is advantageously uniform over the entire surface.

By way of non-limiting example, the pressurizing means may comprise an impermeable flexible film, e.g. of Teflon, placed over the top face of the flat column 3. The pressure exerted on the film by means of a pressurizing fluid presses said film against the top face of the flat column and transfers pressure thereto. When the flat column 3 is initially received in a cassette for insertion into the chamber 17, the top wall of the cassette may optionally comprise the flexible film for external pressurization.

The flexible film may have leaktight passages for inserting samples for treatment and solvents in register with the first locations 19-i of the channel 12-i. Optionally, it is also possible to provide a chamber fitted with inlets for the carrier fluid and inlets for the samples. Naturally, under such circumstances, the injectors 10-i serve to feed the flat column with carrier fluid only, the samples then being introduced directly via the first locations of the flat column 3.

The installation of the invention can operate either by injecting samples via the injection module 6, or by injecting samples directly into the chamber 17, or indeed by introducing samples onto the flat column 3 before it is placed inside the chamber 17.

The external pressure which is applied to the flat column 3 is programmed by means of the control module, as mentioned above. Depending on requirements, this pressure may vary during a separation cycle.

The pressurization fluid may be a gas or a liquid such as oil. The pressurization fluid preferably flows in a closed circuit which opens out into an external pressurization fluid tank, which tank may be housed in the pump module 1 and coupled to a micropump controlled by the control module of the installation.

Other external pressurization means may be envisaged, such as, for example, mechanical, or pneumatic, or analogous means.

The flat column 3 may be fed with carrier fluid and/or samples via microfluidic circuits formed between two Teflon sheets, for example.

Preferably, the flat columns 3 used are of small volume so as to limit the quantity of solvent (or carrier fluid) needed for separation in parallel. Thus, a column having a thickness of 100 micrometers (μm) and having eight parallel separation channels, presents a total volume of 25 microliters (μl) per centimeter (cm) of column length.

The flat column 3 (or stationary phase) may have a plurality of zones that are identical or different, each serving to perform a particular kind of treatment (separation and/or analysis). In which case, the external pressurization means used in the various zones may optionally be different, or they may be identical but apply different pressures.

The installation preferably also has temperature regulation means (not shown). These regulation means serve to regulate the temperature of the flat column 3 and possibly also of the solvent (or carrier fluids). In conventional kinds of separation, temperature is fixed and maintained throughout the separation stage. However, in some cases, it is necessary to cause the temperature to vary during separation so as to change the affinity or the hybridization of certain molecules, for example.

In a variant, instead of varying the temperature inside a single separator chamber, a separator module 7 is provided that is fitted with two chambers 17 connected in series, with the temperatures in the chambers being different. Under such circumstances, as explained below, it is advantageous to provide detector means at the outlet from the first chamber, preferably means of the non-invasive type, that are coupled to valves of the three-port type for the purpose of directing a fraction of the separated sample components as selected by the detector means to the second separator chamber.

The separator chamber 17 may also include electrodes fed by a high-voltage feed module in order to perform separation by electrochromatography or by electrophoresis. Such electrodes may be placed parallel with or perpendicular to the flow, with electrophoresis taking place either simultaneously or sequentially with respect to moving phase separation. Chromatographic and electrophoretic separation can be performed simultaneously or sequentially on the previously-wetted stationary phase by using electrodes that are parallel or perpendicular to the flow. Electrophoresis is naturally performed in a wet phase.

A flat column 3 in a separator chamber 17 is preferably replaced by means of an arm capable of moving in three dimensions under the control of the control module. The arm may optionally be the same arm as the arm used for feeding the injectors 10-i with samples, however it is preferable to use two different, special-purpose arms. For example, the support on which the flat column 3 is placed may be withdrawn by means of a suction cup placed at the end of the arm, or by magnetic adhesion (e.g. when the support for the stationary phase is metallized, it is possible to use a gripping tool fitted with an electromagnet).

The separator chamber 17 is arranged to prevent the air contained in the separation channels 12-i from being discharged while the carrier fluid (or eluent or moving phase) is traveling towards the inlet 19-i of the separation channels 12-i, and until the carrier fluid feed pressure becomes equal to about 80% of the external pressure applied on the flat column 3. Thereafter, the outlets 18-i are opened.

As shown in FIG. 1, the outlets 18-i of the separator chamber 17 feed a detector module for forming a selected type of analysis simultaneously on the various samples separated out in the channels 12-i of the flat column 3. By way of example, the detector module 15 comprises a multiplicity of capillaries 23-i of selected internal diameter and presenting at at least one selected location a transparent zone for allowing a detection light ray to pass either transversely through the thickness thereof, or else longitudinally when the capillary is bent into a Z-type shape. Transverse detection is preferably in preparatory type applications, whereas longitudinal detection provides better sensitivity in analytic type applications.

This type of non-invasive photon detection is preferably performed in the visible and/or the ultraviolet range. It is advantageous to provide a plurality of different types of photon detection in a given installation operating in different wavelength ranges so as to be able to increase the number of possible applications. Under such circumstances, the control module controls the detector module so as to select a wavelength chosen by the user. The detection light may be conveyed to the capillaries 23-i by means of optical fibers 24-i (shown in part) and picked up after passing through the capillaries by other optical fibers (not shown).

Naturally, other types of detection may be provided either instead of the above-described photon detection, or else in addition thereto (in which case said means are referred to as “second” detector means). By way of example, mention can be made of detection by fluorescence, detection by measuring refraction, detection by light diffraction, or detection by mass spectrometry.

When two different types of detection are provided in the installation, it is preferable for them to be connected in series, with the non-invasive detection being placed further upstream. Invasive detection may apply to all or part of the volume of fluid that has been separated out.

The treated samples may be multiplexed either upstream from injection in the detector module or in the spray when the detector module is a mass spectrometer.

It is also possible to make a parallel connection upstream or downstream from the flat column 3 by adding a molecule for revealing directly or indirectly the separated molecules. For example, the molecules concerned may be dye or fluorescent molecules. Such addition needs to be performed while complying with the parameters needed to ensure optimum expression of the resulting coloring (for example nihydrin molecules added to amino acids).

Preferably, and as shown in FIG. 1, the installation has a module 16 for collecting fluid (or moving phase) that is fed by the outlets from the detector module 15. Advantageously, collection is performed individually (or in parallel) via each of the outlets of the detector module 15, e.g. by means of mutually independent collector receptacles 25-i. In order to collect the separated components, it is possible to use receptacles of the tube type, of the micro-slide type, or the like.

In a variant, two independent collector receptacles can be provided at the outlets from each detection channel, coupled to a three-port valve controlled by the control module as a function of the results of detection. This makes it possible to direct those fractions separated out from samples that are not of interest into one of the receptacles, while collecting in the other receptacle those fractions that are deemed to be of interest during detection. Such three-port valves may be placed directly at the ends of the capillaries 23-i of the detector module 15.

In another variant, shown in FIG. 1, provision is also made to have a multiplicity of three-port valves 28-i at the outlets from the capillaries 23-i, but in this case one of the outlets from each valve 28-i controls access to a receptacle 25-i while the other outlet feeds a second detector module 29-i.

The second detector module (or second detection means 29-i) may, in different variants, either perform simultaneously analysis on the treated samples via a multiplicity of paths, or else sequential analysis thereof via a single path. These second detection means are preferably selected from a group comprising a fluorescence detection module, a refraction measuring detection module, a module for detection by light diffraction, and a mass spectrometer module.

In general, any type of collection can be envisaged, either in terms of volume (e.g. collection performed once every n milliliters), or in terms of time (e.g. collection performed once every n seconds), or by detecting the signal on a channel and comparing it with a threshold or with background noise.

The control module is preferably coupled to (or integrated in) a computer 26 possessing display means 27 such as a monitor and user interface means to enable the components of the installation to be programmed and to display the results of simultaneous detections delivered by the various detections modules (15, 29).

As mentioned above, the installation may operate in various different modes. In a first operating mode referred to as “infusion-transfusion” or “in-line”, the constituents separated out by the channels 12-i of the flat column 3 are identified and/or quantified on said flat column 3 and/or outside the chamber 17 by analyzing the moving phase delivered via its various outlets 18-i. In this mode of operation, it is possible to introduce the sample onto the flat column 3 (or stationary phase) prior to infusion, i.e. before introducing the moving phase. However, other procedures are possible, with an infusion step preceding introduction of the sample. The volume needed for such infusion is known to the control module providing it knows the type of stationary phase being used.

When the installation operates in this infusion/transfusion mode, the infusion/transfusion means are preferably located at the outlet (e.g. a control valve placed at the outlet of the stationary phase, as described in document FR 00/00063), thus facilitating the conditioning of a new column and limiting microbubbles of air which are harmful to detecting the constituents separated out from the samples.

In a second mode of operation, referred to as “infusion” or “off-line”, the flat column 3 is used only for separating out the constituents of the sample, with analysis (or determination) and/or quantification of these constituents taking place in an external analyzer after extracting the inside of the separator chamber 17 from the flat column. Any type of analysis known to the person skilled in the art can be envisaged. In this infusion mode, the sample may be placed before or after introduction of the stationary phase into the separator chamber 17. Preferably, the starting material is a “dry” stationary phase 3, i.e. prior to being fed with the moving phase (or carrier fluid). In the infusion/transfusion mode, once separation has terminated, analysis of the constituents is preformed on the stationary phase 3 and/or outside by using the moving phase which leaves the separator chamber 17 via the outlets 18-i.

The invention also provides a method of treating samples by chromatographic separation for implementation in an installation of the type described above.

Numerous applications can be envisaged for the installation of the invention. A first application relates to so-called “normal phase” and “inverse phase” separation. Normal phase separation relates more directly to molecules or macromolecules of the hydrophilic type, whereas inverse phase separation relates more directly to molecules of the hydrophobic type used in so-called “C8” stationary phases (having chains of eight carbon atoms) or so-called “C18” phases (having chains of eighteen carbon atoms).

For example, metabolites are conventionally analyzed in inverse phase, and numerous samples can be analyzed in a very short length of time. Under such circumstances, it is advantageous for the injectors of the injection module to prepare samples by extracting the metabolites from the biological medium. To do this, the pump module establishes a gradient of acetonytrile solvent (pure or mixed) or of methanol solvent (pure or mixed).

A second application relates to screening molecules. Under such circumstances, a ligand is coupled to the head of the stationary phase of the column using techniques that are known in the field of affinity chromatography. The molecules or macromolecules are then injected into the separation channels 12-i, and those which present affinity for the ligand are retained thereby, whereas the others are washed away and eliminated from the column. Thereafter, elution is performed using a suitable solvent (presenting a high salt concentration, or by increasing temperature, or by using a denaturing agent), thereby separating the molecules held by affinity. Another example relates to grafting a specific ligand for each separation channel 12-i. On each cycle, the same molecule or macromolecule is injected into the various separation channels so as to test its affinity with a multiplicity of different ligands. This makes it possible to perform screening on a library of molecules or macromolecules simultaneously.

A particular form of affinity chromatography is immunochromatography in which the ligand is an antibody, preferably a monoclonal antibody. Another form of affinity chromatography is molecular hybridization, in which the ligand is a nucleic acid chain complementary to the nucleic acid that is to be analyzed or separated.

A third application relates to separation by ion exchange.

A fourth application relates to preparatory applications, in particular in combinatorial chemistry or in extracting natural substances.

All of the above techniques are well known to the person skilled in the art.

The invention is not limited to the embodiments of devices and implementations of methods described above purely by way of example, but covers any variant that might be envisaged by the person skilled in the art in the ambit of the following claims.

Thus, depending on the respective positions of the selected first and second locations, separation may be unidirectional or two-directional or circular or anti-circular. However that is well known to the person skilled in the art and does not form the subject matter of the present invention.

Furthermore, an installation is described in which the separator chamber deals only with one or more stationary phases placed side by side on a single support. However, the chamber can be adapted to receive a plurality of stationary phases stacked one on another, with or without supports, and used in series or in is parallel, with or without spacers.

In addition, an embodiment is described in which a liquid moving phase is introduced for entraining the constituents of the sample. However, the invention is equally applicable when a solvent is introduced initially followed by a gas such as air for moving (expelling) the solvent mixed with the constituents of the sample. Air then acts as a kind of moving phase. This technique is known as “flash” chromatography. It results from the above that the “moving phase” should be understood broadly, i.e. as an “entraining fluid”.

1. An installation for treating samples by chromatographic separation, the installation being characterized in that comprises:
means for feeding a moving phase (1, 2, 4) at a selected flow rate and/or a selected limiting pressure;
supply means (14) arranged to deliver a multiplicity of samples separately;
a multiplicity of injector means (10-i) each comprising at least a first inlet (11-i) suitable for receiving a sample delivered by the supply means (14), a second inlet (8-i) connected to the feed means, and at least one outlet (13-i) arranged to deliver the moving phase and/or the sample;
at least one stationary phase (3) defining at least a multiplicity of sample treatment channels (12-i) each starting at a first selected location (19-i) and each opening out at a second selected location (20-i); and
at least one chamber (17) arranged to house said stationary phase (3) and comprising: i) external pressurizing means suitable for applying an external pressure of selected intensity on one face of the stationary phase; ii) a multiplicity of inlets each connected to the outlet (13-i) of a respective injector means (10-i) in such a manner as to deliver the moving phase and/or said samples to different first locations (19-i); and iii) at least a first multiplicity of outlets (18-i) for discharging the multiplicity of samples treated in the channels (12-i) and reaching the various second locations.

2. An installation according to claim 1, characterized in that said injector means (10-i) are selected from the group comprising internal loop injection valves and external loop injection valves.

3. An installation according to claim 1 or claim 2, characterized in that it includes collector means (16) arranged to collect each treated sample and/or moving phase delivered by each of the outlets (18-i) of the chamber (17) in order to store it/them in a receptacle (25-i) of a multiplicity of receptacles.

4. An installation according to claim 3, characterized in that said collector means (16) are arranged to perform collection in a mode selected from the group comprising volume mode, time mode, and signal threshold detection mode.

5. An installation according to claim 3 or claim 4, characterized in that said collector means (16) comprise a multiplicity of outlets together with selector means (28-i) arranged to respond to orders to deliver each collected sample and/or each collected moving phase to a selected one of said receptacles and/or to a selected one of said outlets.

6. An installation according to any one of claims 1 to 5, characterized in that it includes first detector means (15) arranged to analyze sequentially the treated samples as delivered by the various outlets (18-i) of the chamber (17).

7. An installation according to any one of claims 1 to 5, characterized in that it includes first detector means (15) arranged to analyze simultaneously the treated samples as delivered by the various outlets (18-i) of the chamber (17).

8. An installation according to claim 7 in combination with any one of claims 3 to 5, characterized in that said first detector means (15) are installed between said outlets (18-i) of the chamber (17) and said collector means (16).

9. An installation according to any one of claims 3 to 8, characterized in that said first detector means (15) are arranged to perform detection of a non-invasive type, in particular photon detection in the visible and/or the ultraviolet range.

10. An installation according to claim 8 or claim 9, characterized in that it includes second detector means (29-i) arranged to analyze the treated samples simultaneously on a multiplicity of paths, or sequentially on a single path.

11. An installation according to claim 10, characterized in that said second detector means are selected from the group comprising a fluorescence detection module, a refraction measuring detection module, a module for detection by light diffraction, and a mass spectrometer module.

12. An installation according to any one of claims 3 to 11, characterized in that it includes memory means (26) arranged to store the results delivered by said detector means (15, 29).

13. An installation according to any one of claims 1 to 12, characterized in that said chamber (17) includes electrodes fed by a high-voltage feed module so as to perform separation by electrochromatography, said electrodes being placed parallel with or perpendicular to the flow.

14. An installation according to any one of claims 1 to 13, characterized in that said sample supply means (14) comprise a sample handling device capable of moving in three dimensions and arranged to feed the various first inlets (11-i) of the injector means (10-i) with samples.

15. An installation according to any one of claims 1 to 14, characterized in that said chamber (17) is arranged to receive an extractable drawer containing said stationary phase.

16. An installation according to any one of claims 1 to 15, characterized in that it includes regulator means arranged to control the temperature of at least a portion of the stationary phase (3) inside the chamber (17).

17. An installation according to any one of claims 1 to 16, characterized in that at least some of said channels (12-i) formed on a stationary phase (3) are substantially trapezoidal in shape.

18. The use of an installation according to any preceding claim in normal phase separation or in inverse phase separation.

19. The use of an installation according to any one of claims 1 to 17 in screening molecules by affinity chromatography, in particular by immunochromatography or by molecular hybridization.

20. The use of an installation according to any one of claims 1 to 17, in separation by ion exchange.

21. The use of an installation according to any one of claims 1 to 17, in preparing samples for combinatorial chemistry or for extracting natural substances.
